(19) United States
(12) Patent Application Publication
(10) Pub. No.: US 2014/0376093 A1
(43) Pub. Date: Dec. 25, 2014

(54) Diffractive Optical Element and Optical Device Having the Same

(71) Applicant: LG INNOTEK CO., LTD., Seoul (KR)

(72) Inventors: Sang Hun Lee, Seoul (KR); Dowon Yi, Seoul (KR)

(73) Assignee: LG INNOTEK CO., LTD., Seoul (KR)

(21) Appl. No.: 14/291,090

(22) Filed: May 30, 2014

(30) Foreign Application Priority Data
Jun. 24, 2013 (KR) 10-2013-0072621
Jul. 8, 2013 (KR) 10-2013-0079589
Jul. 8, 2013 (KR) 10-2013-0079590

(51) Int. Cl. G02B 5/18

(52) U.S. Cl. CPC G02B 5/18
USPC 359/575

(57) ABSTRACT

There are provided a diffractive optical element in which a diffraction pattern is formed on at least one surface, wherein a height of the diffraction pattern changes from a center to an edge of the one surface, and a height of a first diffraction pattern element formed at the center and a height of a second diffraction pattern element formed at the edge are different, and an optical device having the same.

### CROSS-REFERENCE TO RELATED APPLICATIONS

This application claims the benefit under 35 U.S.C. §119 of Korean Patent Application Nos. 10-2013-0072621, filed Jun. 24, 2013, 10-2013-0079589, filed Jul. 8, 2013, and 10-2013-0079590, filed Jul. 8, 2013, which are hereby incorporated by reference in their entirety.

### BACKGROUND

1. Field of the Invention

The present invention relates to a diffractive optical element in which diffraction efficiency according to a wavelength and an angle of incidence is uniform.

2. Discussion of Related Art

In a diffractive optical element (DOE), a manner in which chromatic aberration occurs is opposite to that of a refractive optical system having the same sign power. This is based on a physical phenomenon in which chromatic aberration of light of a reference wavelength inversely occurs at a refractive surface and a diffractive surface in an optical system.

A DOE is advantageous in that aberration correction is easier than in an existing refractive optical system, a height of a lens assembly can be decreased, it can be manufactured in a small size, and a product cost can be decreased according to a decrease in the number of lenses.

However, a DOE has a problem in that a diffraction efficiency difference occurs according to a wavelength band of incident light and an angle of incidence of a lens, which causes a flare phenomenon and performance degradation of an image.

In order to address such a problem, techniques for improving diffraction efficiency by stacking a plurality of DOEs have been developed. However, when only a single DOE is used, the diffraction efficiency difference according to the wavelength and the angle of incidence is not improved.

### BRIEF SUMMARY

The present invention provides a diffractive optical element (DOE) in which diffraction efficiency according to a wavelength and an angle of incidence is similar.

The present invention provides a thin-film DOE that is designed as a single DOE.

According to an aspect of the present invention, there is provided a DOE in which a diffraction pattern is formed on at least one surface, wherein a height of the diffraction pattern changes from a center to an edge of the one surface, and a height of a first diffraction pattern element formed at the center and a height of a second diffraction pattern element formed at the edge are different.

A difference between the height of the first diffraction pattern element and the height of the second diffraction pattern element may be 600 nm to 1400 nm.

The height of the first diffraction pattern element may be greater than the height of the second diffraction pattern element.

The height of the first diffraction pattern element may be 1500 nm to 1900 nm, and the height of the second diffraction pattern element may be 500 nm to 900 nm.

A height (hₒ) of the first diffraction pattern element may satisfy the following Equation 1, and a height (h₁) of the second diffraction pattern element may satisfy the following Equation 2.

$$\begin{matrix}{h}_{o} = \frac{{λ}_{1}}{{n}_{d} - 1} & [ Equation 1 ] \\ {h}_{1} = \frac{{λ}_{2}}{{n}_{d} - 1} & [ Equation 2 ]\end{matrix}$$

(here n_{d} is a refractive index of the DOE, 750 nm≦λ₁≦950 nm, and 250 nm≦λ₂≦450 nm)

A height (hᵣ) of a diffraction pattern that changes from a center to an edge of the one surface may satisfy the following Equation 3.

$$h ( r ) = {h}_{0} - ( \frac{{h}_{0} - {h}_{1}}{{{r}_{eff}}^{γ}} ) {r}^{γ} \qquad [ Equation 3 ]$$

(here hₒ is a height of the first diffraction pattern element, h₁ is a height of the second diffraction pattern element, r_{eff} is a radius of an effective diameter, r is a radius of a corresponding diffraction pattern, and 0.1≦γ≦3)

According to another aspect of the present invention, there is provided a DOE in which a diffraction pattern is formed on at least one surface, wherein a height of the diffraction pattern changes from a center to an edge of the one surface, first-order light diffraction efficiency of red light (R1), green light (G1), and blue light (B1), which pass through the center, satisfies the following Relation 1, and first-order light diffraction efficiency of red light (R2), green light (G2), and blue light (B2), which pass through the edge, satisfies the following Relation 2.

R1>G1>B1 [Relation 1]

R2<G2<B2 [Relation 2]

According to still another aspect of the present invention, there is provided a DOE in which a diffraction pattern is formed on at least one surface, wherein a height of the diffraction pattern changes from a center to an edge of the one surface, and first-order light diffraction efficiency of incident visible light is 0.6 or more.

A first-order light diffraction efficiency difference among green light, blue light, and red light out of the visible light may be 0.2 or less.

When an angle of light incident on the DOE has a range of 0 to 40, first-order light diffraction efficiency of the visible light may be 0.6 or more.

When an angle of light incident on the diffraction element has a range of 0 to 40, the first-order light diffraction efficiency difference among green light, blue light, and red light out of the visible light may be 0.2 or less.

A wavelength of the blue light may be 400 to 500 nm, a wavelength of the green light may be 500 to 600 nm, and a wavelength of the red light may be 600 to 700 nm.

A height of a first diffraction pattern element formed at the center may be greater than a height of a second diffraction pattern element formed at the edge.

According to yet another aspect of the present invention, there is provided a DOE in which a diffraction pattern is formed on at least one surface, wherein a height of the diffraction pattern changes from a center to an edge of the one surface, and first-order light diffraction efficiencies of blue light and red light out of incident visible light are different at the center and the edge.

First-order light diffraction efficiencies of the blue light and the red light may change from the center to the edge.

An interval in which first-order light diffraction efficiencies of the blue light and the red light are reversed may be formed between the center and the edge.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a side view of a diffractive optical element (DOE) according to an embodiment of the present invention;

FIG. 2 is a graph showing a gradient change of a diffraction pattern height according to a constant (γ) change of Equation 3;

FIG. 3 is a diagram illustrating wavelength dependency of the DOE according to the embodiment of the present invention;

FIG. 4 is a diagram illustrating wavelength dependency of a DOE in which heights of diffraction patterns are the same;

FIG. 5 is a side view and a plan view of a DOE according to another embodiment of the present invention;

FIG. 6 is a diagram illustrating a shape in which the DOE according to the present invention is combined with an aspherical lens;

FIG. 7 is a graph showing first-order light efficiency of the DOE illustrated in FIG. 4;

FIG. 8 is a graph showing first-order light efficiency of the DOE according to the embodiment of the present invention;

FIG. 9 is a photographic image captured by an optical device including the DOE illustrated in FIG. 4;

FIG. 10 is a photographic image captured by an optical device including the DOE according to the embodiment of the present invention; and

FIG. 11 is a photographic image captured by an existing optical device.

### DETAILED DESCRIPTION

While the present invention can be modified in various ways and take on various alternative forms, specific embodiments thereof are shown in the drawings and described in detail below as examples.

Terms including ordinal numbers such as first and second may be used to describe various elements, but the elements are not limited by the terms.

The terms are used only to distinguish one element from another. For example, a second element could be termed a first element, and a first element could be termed a second element, without departing from the scope of the present invention.

It will be understood that when an element is referred to as being “connected” or “coupled” to another element, it can be directly connected or coupled to the other element or intervening elements may be present.

In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a,” “an” and “the” are intended to include the plural forms as well, unless the context clearly indicates otherwise.

It will be further understood that the terms “comprises,” “comprising,” “includes” and/or “including,” when used herein, specify the presence of stated features, integers, steps, operations, elements, components, or combinations thereof but do not preclude the presence or addition of one or more other features, integers, steps, operations, elements, components, or combinations thereof.

Also, it will be understood that the accompanying drawings of the present invention are enlarged or reduced for convenience of description.

Hereinafter, the present invention will be described in detail with reference to the drawings. Like reference numerals are assigned to the same or corresponding elements even in different drawings. Redundant description thereof will not be repeated.

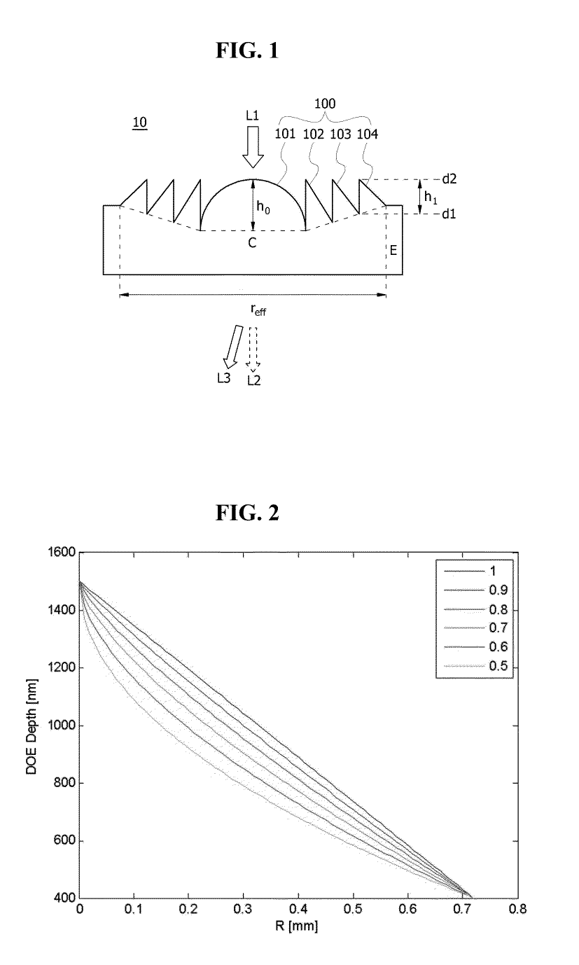

FIG. 1 is a side view of a diffractive optical element (DOE) according to an embodiment of the present invention. FIG. 2 is a graph showing a gradient change of a diffraction pattern height according to a constant (γ) change of Equation 3.

As illustrated in FIG. 1, in a DOE 10 according to an embodiment of the present invention, a diffraction pattern 100 comprises a plurality of diffraction pattern elements. The diffraction pattern 100 may be formed on at least one surface. The diffraction pattern 100 may have a sawtooth shape (Fresnel DOE shape), and incident light (L1) is diffracted into zeroth-order light (L2), first-order light (L3), and the like. Hereinafter, diffraction efficiency will be described as first-order light diffraction efficiency.

A height of the diffraction pattern 100 continuously or discontinuously changes from a center (C) to an edge (E) of the DOE. In this case, the height of the diffraction pattern 100 may be designed such that it decreases from the center to the edge, or alternatively, increases from the center to the edge. In the following description, it is designed such that the height of the diffraction pattern 100 decreases from the center to the edge, and the height of the diffraction pattern may be defined as a distance between a peak (d2) and a valley (d1) of a sawtooth-shaped pattern.

A height (hₒ) of a diffraction pattern at the center (hereinafter referred to as a first diffraction pattern element 101) is formed higher than a height (h₁) of a diffraction pattern at the edge (hereinafter referred to as a second diffraction pattern element 104). In addition, heights of diffraction pattern elements 102 and 103 between the first diffraction pattern element 101 and the second diffraction pattern element 104 successively decrease. The height (hₒ) of the first diffraction pattern element may be designed to satisfy the following Equation 1, and the height (h₁) of the second diffraction pattern element may be designed to satisfy the following Equation 2.

$$\begin{matrix}{h}_{o} = \frac{{λ}_{1}}{{n}_{d} - 1} & [ Equation 1 ] \\ {h}_{1} = \frac{{λ}_{2}}{{n}_{d} - 1} & [ Equation 2 ]\end{matrix}$$

Here, n_{d} is a refractive index (1.5 to 1.6) of the DOE, 750 nm≦λ₁≦950 nm, and 250 nm≦λ₂≦450 nm.

In this case, a range of λ₁ and a range of λ₂ are designed such that the first-order light diffraction efficiency of the incident light is 0.5 or more. Therefore, when the refractive index (n_{d}) of the DOE is 1.5, the height (hₒ) of the first diffraction pattern element may be 1500 nm to 1900 nm, the height (h₁) of the second diffraction pattern element may be 500 nm to 900 nm, and a difference between the height (hₒ) of the first diffraction pattern element and the height (h₁) of the second diffraction pattern element may be 600 nm to 1400 nm.

Therefore, light of a long wavelength band has high diffraction efficiency at the center of the DOE, and has low diffraction efficiency at the edge of the DOE. On the other hand, light of a short wavelength band has high diffraction efficiency at the edge of the DOE and has low diffraction efficiency at the center of the DOE. As a result, it may be controlled such that total diffraction efficiency of a long wavelength and a short wavelength which pass through the DOE becomes similar.

A height (hᵣ) of each of the diffraction patterns 102 and 103 that changes from the center to the edge of the DOE is designed to satisfy the following Equation 3.

$$h ( r ) = {h}_{0} - ( \frac{{h}_{0} - {h}_{1}}{{{r}_{eff}}^{γ}} ) {r}^{γ} \qquad [ Equation 3 ]$$

Here, hₒ is a height of the first diffraction pattern element 101, h₁ is a height of the second diffraction pattern element 104, r_{eff} is a radius of an effective diameter, r is a radius of a corresponding diffraction pattern, and 0.1≦γ≦3.

Accordingly, the plurality of diffraction patterns 102 and 103 disposed between the first diffraction pattern element 101 and the second diffraction pattern element 104 have a height defined by Equation 3.

In general, the DOE includes an effective radius (r_{eff}) having a diffraction effect and an outer side thereof may be defined as a processing diameter for pattern processing. Therefore, the second diffraction pattern element 104 is defined as a diffraction pattern disposed at an end of the effective diameter (disposed at the outermost side).

In Equation 3, γ is a gradient constant, and a gradient of a diffraction pattern height is determined by a size of γ. In the following Table 1, when a height (hₒ) of the first diffraction pattern element is 1500 nm and the height (h₁) of the second diffraction pattern element is 400 nm, heights of the diffraction patterns that change according to a change of γ are shown.

TABLE 1

| γ | Ring 1 | Ring 2 | Ring 3 | Ring 4 | Ring 5 |
|---|---|---|---|---|---|
| 1 | 1500 | 1053 | 855 | 696 | 553 |
| 0.9 | 1500 | 1001 | 820 | 671 | 539 |
| 0.8 | 1500 | 963 | 783 | 644 | 524 |
| 0.7 | 1500 | 913 | 743 | 617 | 509 |
| 0.6 | 1500 | 858 | 702 | 589 | 494 |
| 0.5 | 1500 | 797 | 548 | 560 | 479 |

Referring to FIG. 2 and Table 1, when a value of γ is 0.5, the gradient rapidly decreases. However, when a value of γ is 1, the height of the pattern gradually linearly decreases. That is, Equation 3 may be defined as the gradient (hᵣ) of the diffraction pattern height.

In this case, a range of γ satisfies 0.1≦γ≦3. When γ is less than 0.1 or more than 3, the height of the diffraction pattern sharply decreases, which results in difficulty of processing the diffraction pattern.

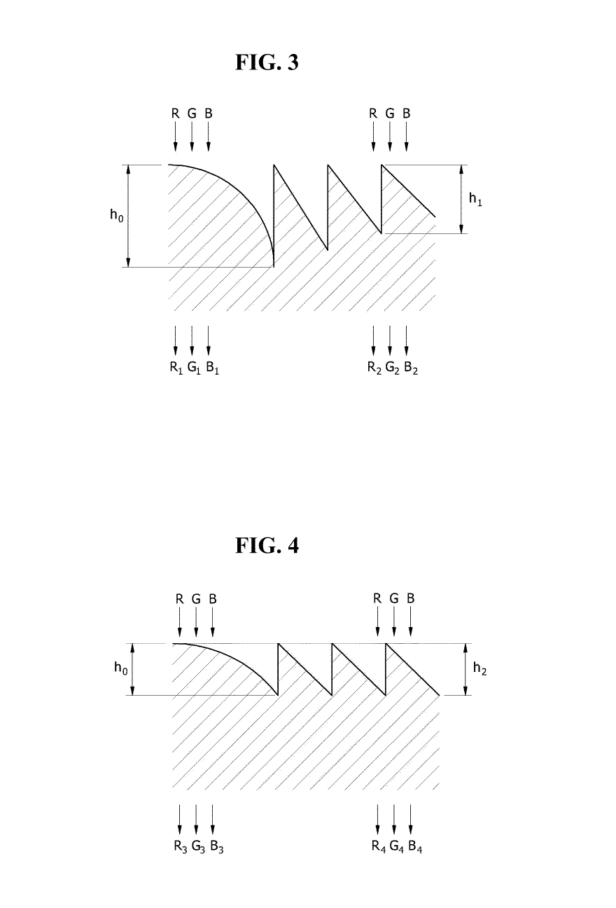

FIG. 3 is a diagram illustrating wavelength dependency of the DOE according to the embodiment of the present invention. FIG. 4 is a diagram illustrating wavelength dependency of a DOE in which heights of diffraction patterns are the same.

As illustrated in FIG. 3, in the DOE according to the embodiment of the present invention, the height of the diffraction pattern decreases from the center (C) to the edge (E). In addition, as described above, diffraction efficiency of the long wavelength relatively increases at the center, and diffraction efficiency of the short wavelength relatively increases at the edge.

Accordingly, efficiencies of red light (R1) of 600 to 700 nm, green light (G1) of 500 to 600 nm, and blue light (B1) of 400 to 500 nm, which pass through the center, satisfy the following Relation 1.

R1>G1×B1 [Relation 1]

In other words, at the center, the red light has the highest first-order light diffraction efficiency and the blue light has the lowest first-order light diffraction efficiency. On the other hand, efficiencies of red light (R2) of 600 to 700 nm, green light (G2) of 500 to 600 nm, and blue light (B2) of 400 to 500 nm, which pass through the edge, satisfy the following Relation 2.

R2<G2<B2 [Relation 2]

Thus, the DOE 10 has an interval in which first-order light diffraction efficiencies of the blue light and the red light are reversed. The interval may be formed between the center (C) and the edge (E) of the DOE 10. Accordingly, total diffraction efficiency of the red light, the green light, and the blue light which pass through the DOE may be controlled to be similar.

When heights (h₂) of diffraction patterns are equally formed as illustrated in FIG. 4, light of a wavelength band corresponding to a design wavelength has maximum efficiency, but light of the remaining wavelength band has very low diffraction efficiency.

When the design wavelength is green light of 546 nm, efficiency of only the green light is high at the center and the edge (G3>>R3=B3, G4>>R4=B4). In such a DOE, due to a difference of diffraction efficiencies according to the wavelengths, a flare phenomenon occurs.

Referring again to FIG. 3, in the DOE according to the present invention, dependency on an angle of incidence decreases. For example, it is assumed that first light is incident at a first angle and second light is incident at a second angle. When the first light has high diffraction efficiency at the center, the vicinity of the edge in which heights of diffraction patterns are different has low diffraction efficiency. When the second light has low efficiency at the center, the edge in which heights of diffraction patterns are different has high diffraction efficiency. Accordingly, first-order light diffraction efficiency according to the angle of incidence is controlled to be similar.

In other words, when a wavelength changes and an angle of incidence changes, a part having high or low efficiency in one area (center) due to a height change of diffraction patterns is compensated for by another area (edge). Accordingly, total diffraction efficiency of light passing through the DOE may be controlled to be similar.

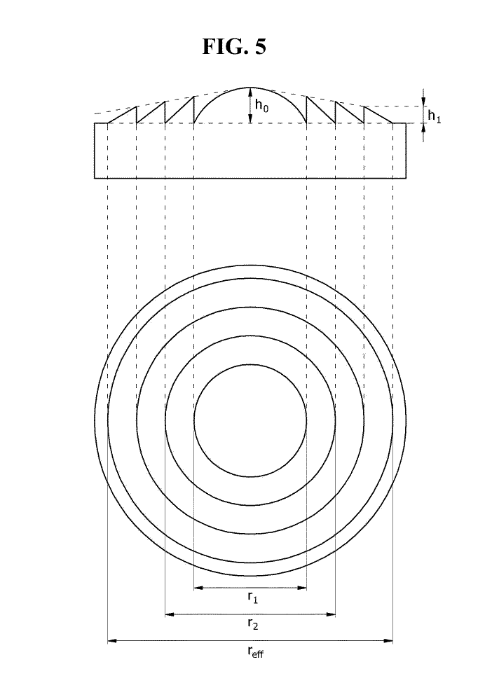

FIG. 5 is a side view and a plan view of a DOE according to another embodiment of the present invention. FIG. 6 is a diagram illustrating a shape in which the DOE according to the present invention is combined with an aspherical lens.

As illustrated in FIG. 5, the DOE according to another embodiment of the present invention is designed such that a peak of a diffraction pattern becomes lower from a center to an edge and a height thereof gradually decreases. This is the same as the height of the pattern decreasing as the valley (d1) of the diffraction pattern changes in FIG. 1. In this case, each diffraction pattern is formed in a ring shape (r₁ and r₂).

As illustrated in FIG. 6, the DOE 10 may be formed on a surface of an aspherical lens 20. The aspherical lens 20 may include a convex lens and a concave lens. Therefore, by the DOE 10, it is possible to effectively correct chromatic aberration occurring in a refractive optical system.

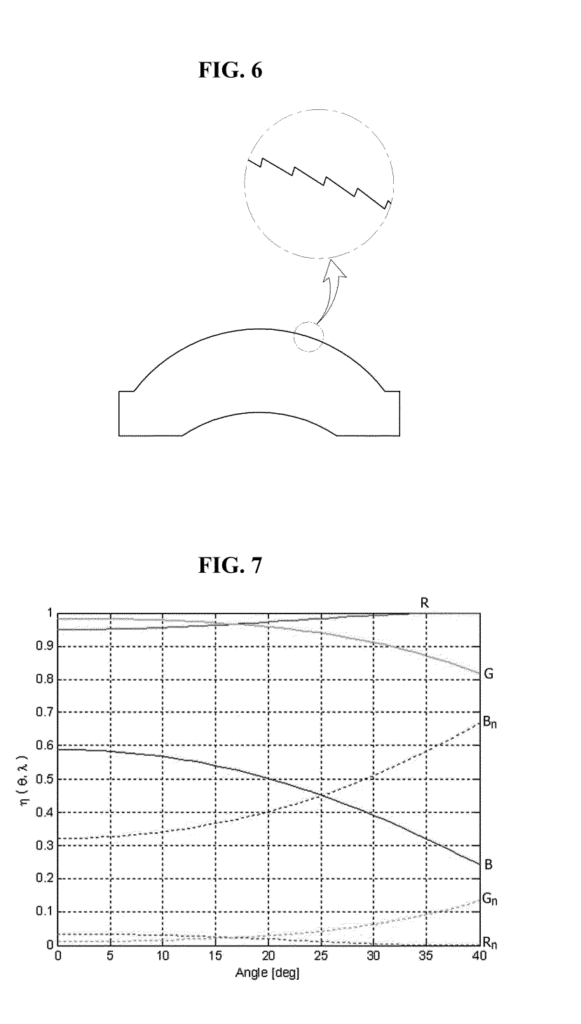

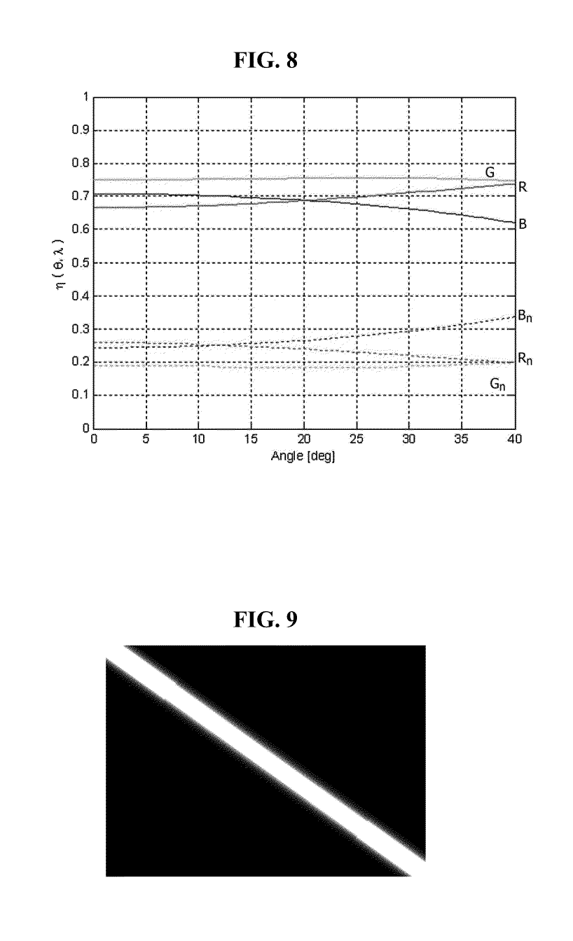

FIG. 7 is a graph showing first-order light efficiency of the DOE illustrated in FIG. 4. FIG. 8 is a graph showing first-order light efficiency of the DOE according to the embodiment of the present invention.

In this case, first-order light diffraction efficiency (η) in FIG. 8 is a simulation result of an outcome calculated by the following Equation 4.

$${η}_{m} ( λ , {θ}_{2} ) = \frac{2 π {\int }_{0}^{{r}_{eff}} sin {c}^{2} \{ \frac{{h}_{0} ( r )}{λ} [ \begin{matrix}\sqrt{{{n}_{1} ( λ )}^{2} - {{n}_{2} ( λ )}^{2} {sin}^{2} {θ}_{2}} - \\ {n}_{2} ( λ ) cos {θ}_{2}\end{matrix} ] {n}_{2} ( λ ) cos {θ}_{2} - m \} r d r}{π {r}_{eff}^{2}} \qquad [ Equation 4 ]$$

Here, λ is a wavelength of incident light, n₁ is a refractive index of the DOE, n₂ is a refractive index of air, θ₂ is an angle of incidence, and m is an order of diffraction.

As illustrated in FIG. 7, the DOE (refer to FIG. 4) in which heights of diffraction patterns are equally formed has maximum efficiency at a design wavelength (for example, 546 nm, G), but efficiency rapidly decreases to 0.6 or less at a wavelength band (B) other than the design wavelength. Also, efficiency rapidly changes according to an angle of incidence. An efficiency difference for each wavelength band and an efficiency difference according to the angle of incidence cause a flare problem. In this case, dotted lines (Bn, Gn, and Rn) represent light other than first-order light, which causes noise in a real image.

On the other hand, in the DOE according to the embodiment of the present invention in FIG. 8, first-order light diffraction efficiency for each wavelength band is almost the same. Specifically, all first-order light diffraction efficiencies of light of a red wavelength band (R), a green wavelength band (G), and a blue wavelength band (B) uniformly fall within 0.6 to 0.8. The COE 10 has an interval in which first-order light diffraction efficiencies of the blue light and the red light are reversed according to the angle of incidence. Therefore, total diffraction efficiency of the red light, the green light, and the blue light which pass through the DOE may be controlled to be similar and there is no substantial efficiency change according to the angle of incidence.

As a result, wavelength dependency and angle of incidence dependency of the DOE are mitigated, which contributes to effectively addressing the flare problem.

In addition, since the DOE according to the present invention is designed as a single-layer structure rather than a stacked element in which a plurality of diffraction patterns are stacked, it is possible to design a thin DOE. Therefore, it is possible to implement a compact optical system having the same.

Also, such a DOE may be applied to various optical instruments such as a camera module for a communication terminal, a digital still camera, and a camcorder.

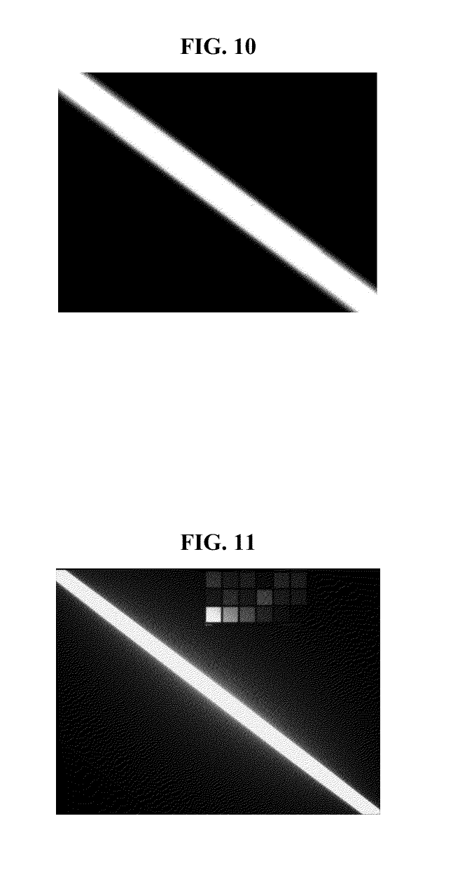

FIG. 9 is a photographic image captured by an optical device including the DOE illustrated in FIG. 4. FIG. 10 is a photographic image captured by an optical device including the DOE according to the embodiment of the present invention. FIG. 11 is a photographic image captured by an existing optical device.

As illustrated in FIG. 9, in the photographic image captured by an optical device (for example, a camera module) on which the DOE in which heights of diffraction patterns were the same was mounted, a purple flare was observed at a center field (0.1F), and a blue flare was observed at a border (0.7F). It is observed that the flare was much larger than that of the image captured by a refractive optical system in FIG. 11.

On the other hand, in the photographic image captured by an optical device on which the DOE according to the embodiment of the present invention was mounted in FIG. 10, it is observed that a color difference between a center field (0.1F) and a border (0.7F) is not great. This result shows that the flare problem is significantly mitigated compared to the image captured by the refractive optical system in FIG. 11.

According to the present invention, when only a single DOE is used, diffraction efficiency according to a wavelength and an angle of incidence may be controlled to be similar.

Also, a color difference (color variation) for each field occurring due to a diffraction efficiency difference in the DOE optical system decreases. As a result, it is possible to implement uniform light (white light) for all areas.

What is claimed is:

1. A diffractive optical element (DOE) having a diffraction pattern formed on at least one surface thereof,
wherein the diffraction pattern comprises a plurality of diffraction pattern elements,
wherein a height of the diffraction pattern changes from a center to an edge of the one surface, and a height of a first diffraction pattern element formed at the center and a height of a second diffraction pattern element formed at the edge are different, and
wherein the height is defined as a distance between a peak and a valley of a diffraction pattern element.

2. The DOE of claim 1, which is a single layer.

3. The DOE of claim 1,
wherein a difference between the height of the first diffraction pattern element and the height of the second diffraction pattern element is 600 nm to 1400 nm.

4. The DOE of claim 1,
wherein the height of the first diffraction pattern element is greater than the height of the second diffraction pattern element.

5. The DOE of claim 4,
wherein the height of the first diffraction pattern element is 1500 nm to 1900 nm, and the height of the second diffraction pattern element is 500 nm to 900 nm.

6. The DOE of claim 1,
wherein a height (hₒ) of the first diffraction pattern element satisfies the following Equation 1, and a height (h₁) of the second diffraction pattern element satisfies the following Equation 2,
$$\begin{matrix}{h}_{o} = \frac{{λ}_{1}}{{n}_{d} - 1} & [ Equation 1 ] \\ {h}_{1} = \frac{{λ}_{2}}{{n}_{d} - 1} & [ Equation 2 ]\end{matrix}$$
(where n_{d} is a refractive index of the DOE, 750 nm≦λ₁≦950 nm, and 250 nm≦λ₂≦450 nm).

7. The DOE of claim 1,
wherein a height (hᵣ) of the diffraction pattern between the first diffraction pattern element and the second diffraction pattern element satisfies the following Equation 3,
$$h ( r ) = {h}_{0} - ( \frac{{h}_{0} - {h}_{1}}{{{r}_{eff}}^{γ}} ) {r}^{γ} \qquad [ Equation 3 ]$$
(where hₒ is a height of the first diffraction pattern element, h₁ is a height of the second diffraction pattern element, r_{eff} is a radius of an effective diameter, r is a radius of a corresponding diffraction pattern element, and 0.1≦γ≦3).

8. A diffractive optical element (DOE) having a diffraction pattern on at least one surface thereof,
wherein first-order light diffraction efficiency of red light (R1), green light (G1), and blue light (B1), which pass through the center thereof, satisfies the following Relation 1, and first-order light diffraction efficiency of red light (R2), green light (G2), and blue light (B2), which pass through the edge thereof, satisfies the following Relation 2,
R1>G1>B1 [Relation 1]
R2<G2<B2. [Relation 2]

9. The DOE of claim 8,
wherein the diffraction pattern comprises a plurality of diffraction pattern elements,
wherein a height of the diffraction pattern changes from a center to an edge of the one surface,
wherein the height is defined as a distance between a peak and a valley of a diffraction pattern element, and
wherein a height of a first diffraction pattern element formed at the center is greater than a height of a second diffraction pattern element formed at the edge.

10. The DOE of claim 9,
wherein the height (hₒ) of the first diffraction pattern element satisfies the following Equation 1, and the height (h₁) of the second diffraction pattern element satisfies the following Equation 2,
$$\begin{matrix}{h}_{o} = \frac{{λ}_{1}}{{n}_{d} - 1} & [ Equation 1 ] \\ {h}_{1} = \frac{{λ}_{2}}{{n}_{d} - 1} & [ Equation 2 ]\end{matrix}$$
(where n_{d} is a refractive index of the DOE, 750 nm≦λ₁≦950 nm, and 250 nm≦λ₂≦450 nm).

11. The DOE of claim 9,
wherein a height (hᵣ) of the diffraction pattern between the first diffraction pattern element and the second diffraction pattern element satisfies the following Equation 3,
$$h ( r ) = {h}_{0} - ( \frac{{h}_{0} - {h}_{1}}{{{r}_{eff}}^{γ}} ) {r}^{γ} \qquad [ Equation 3 ]$$
(where hₒ is a height of the first diffraction pattern element, h₁ is a height of the second diffraction pattern element, r_{eff} is a radius of an effective diameter, r is a radius of a corresponding diffraction pattern element, and 0.1≦γ≦3).

12. The DOE of claim 8,
wherein the red light is light of a wavelength band of 600 to 700 nm, the green light is light of a wavelength band of 500 to 600 nm, and the blue light is light of a wavelength band of 400 to 500 nm.

13. A diffractive optical element (DOE) having a diffraction pattern formed on at least one surface thereof,
wherein the diffraction pattern comprises a plurality of diffraction pattern elements, wherein a height of the diffraction pattern changes from a center to an edge of the one surface,
wherein the height is defined as a distance between a peak and a valley of a diffraction pattern element, and
wherein a first-order light diffraction efficiency of incident visible light is 0.6 or more.

14. The DOE of claim 13,
wherein the first-order light diffraction efficiency difference among green light, blue light, and red light out of the visible light is 0.2 or less.

15. The DOE of claim 13,
wherein, when an angle of light incident on the DOE has a range of 0 to 40, and wherein the first-order light diffraction efficiency of the visible light is 0.6 or more.

16. The DOE of claim 14,
wherein, when an angle of light incident on the DOE has a range of 0 to 40, and wherein the first-order light diffraction efficiency difference among green light, blue light, and red light out of the visible light is 0.2 or less.

17. The DOE of claim 16,
wherein a wavelength of the blue light is 400 to 500 nm, a wavelength of the green light is 500 to 600 nm, and a wavelength of the red light is 600 to 700 nm.

18. A diffractive optical element (DOE) having a diffraction pattern formed on at least one surface thereof,
wherein the diffraction pattern comprises a plurality of diffraction pattern elements,
wherein a height of the diffraction pattern changes from a center to an edge of the one surface,
wherein the height is defined as a distance between a peak and a valley of a diffraction pattern element, and
wherein first-order light diffraction efficiencies of blue light and red light out of incident visible light are different at the center and the edge.

19. The DOE of claim 18,
wherein an interval in which first-order light diffraction efficiencies of the blue light and the red light are reversed is formed between the center and the edge.

20. An optical device, comprising the DOE of claim 1.
